(19) United States
(12) Patent Application Publication
(10) Pub. No.: US 2026/0264431 A1
(43) Pub. Date: Sep. 10, 2026

(54) CLEANING METHOD FOR LIQUID EJECTION HEAD

(71) Applicant: CANON KABUSHIKI KAISHA, Tokyo (JP)

(72) Inventor: YUZURU ISHIDA, Kanagawa (JP)

(21) Appl. No.: 19/556,671

(22) Filed: Mar. 4, 2026

(30) Foreign Application Priority Data
Mar. 10, 2025 (JP) 2025-037821

(51) Int. Cl. B41J 29/17; B08B 7/00; B41J 2/14; C09D 11/037; C09D 11/322; C09D 11/52

(52) U.S. Cl. CPC B41J 29/17; B08B 7/00; B41J 2/14072; B41J 2/14096; C09D 11/037; C09D 11/322; C09D 11/52; B41J 2002/14491

(57) ABSTRACT

A cleaning method for a liquid ejection head that includes an ejection outlet configured to eject liquid, a heat generating element configured to heat the liquid to eject the liquid from the ejection outlet, a first electrode disposed on the heat generating element and configured to protect the heat generating element, and a second electrode electrically connected to the first electrode via the liquid includes applying a voltage equal to or higher than an elution potential of metal precipitate and lower than an elution potential of a substance from the first electrode between the first electrode and the second electrode to remove the metal precipitate from the first electrode when the liquid is ejected from the ejection outlet.

### BACKGROUND

### Field of the Technology

The present disclosure relates to a cleaning method for a liquid ejection head that ejects liquid.

### Description of the Related Art

Currently, many liquid ejection devices are employed that use a method of ejecting droplets from ejection outlets by bubbling energy generated by film boiling in the liquid due to heat applied to the liquid in a liquid chamber by energization of heat generating elements.

In such a liquid ejection device, a physical action, such as impact due to cavitation generated when a bubble forms, contracts, and collapses, may be exerted on a region on the heat generating element. Further, when liquid is ejected, since the heat generating element is at high temperature, a chemical action, such as thermal decomposition of components of the liquid and then adhesion thereof to be fixed to and deposited on the heat generating element, may be exerted on the region on the heat generating element.

In order to protect the heat generating element from these physical and chemical actions, a protective layer formed of a metal material or the like to cover the heat generating element is arranged on the heat generating element.

Here, on a thermal action portion in contact with the liquid on the protective layer on the heat generating element, a phenomenon occurs in which a coloring material and an additive included in the liquid are decomposed at a molecular level by being heated at high temperature, change into a sparingly soluble substance, and are physically adsorbed onto the thermal action portion. This phenomenon is referred to as "kogation". Thus, sparingly soluble organic and inorganic substances adsorbed on the thermal action portion of the protective layer cause the thermal conduction from the thermal action portion to the liquid to be uneven, resulting in unstable bubbling.

Japanese Patent No. 6918636 describes a technique of applying a voltage between an upper protective layer including iridium and a counter electrode to repel negatively charged solid content in ink, such as pigment or latex, which may cause kogation, from the upper protective layer, reducing kogation adhesion.

Further, Japanese Patent No. 4926669 describes a method of removing kogation adhering onto an upper protective layer by lift-off by eluting a substance from the surface of the upper protective layer formed of iridium or ruthenium as the substance into liquid by an electrochemical reaction. Specifically, Japanese Patent No. 4926669 describes a kogation removal cleaning method which is performed while applying a voltage of 10 V between the upper protective layer and a counter electrode in order to elute the substance from the upper protective layer by an electrochemical reaction.

On the other hand, ink contains a trace amount of positively charged metal impurity ions in addition to negatively charged solid content, such as pigment and latex. As a result, when a voltage is applied between the respective electrodes so that the upper protective layer is the negative electrode as described in Japanese Patent No. 6918636, the metal impurity ions in the ink adhere onto the upper protective layer, are reduced and become metal, which precipitates and deposits.

Although kogation made of such a metal inorganic substance can also be removed by the kogation removal cleaning method described above, the kogation is removed while a substance is eluted from the upper protective layer. Thus, repeated executions of the cleaning cause the upper protective layer gradually to become thin, which generates a concern that the heat generating element would be damaged by cavitation at the time of ink bubbling.

### SUMMARY

In view of the above description, the present disclosure is directed to providing a cleaning method capable of removing metal precipitate on an upper protective layer while preventing film reduction of the upper protective layer.

According to an aspect of the present disclosure, a cleaning method for a liquid ejection head that includes an ejection outlet configured to eject liquid, a heat generating element configured to heat the liquid to eject the liquid from the ejection outlet, a first electrode disposed on the heat generating element and configured to protect the heat generating element, and a second electrode electrically connected to the first electrode via the liquid includes applying a voltage equal to or higher than an elution potential of metal precipitate and lower than an elution potential of a substance from the first electrode between the first electrode and the second electrode to remove the metal precipitate from the first electrode when the liquid is ejected from the ejection outlet.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic perspective views of a liquid ejection head.

FIGS. 2A and 2B are schematic views of a recording element substrate.

FIG. 3 is a schematic cross-sectional view of the recording element substrate.

FIGS. 4A to 4C are schematic views of the recording element substrate.

FIGS. 5A and 5B are schematic views of kogation suppression processing.

FIGS. 6A to 6C are schematic diagrams of metal copper precipitation.

FIG. 7 is a diagram of voltage application for kogation removal of a conventional technique.

FIG. 8 is a diagram of voltage application for metal precipitate removal.

### DESCRIPTION OF THE EMBODIMENTS

Hereinafter, an embodiment of the present disclosure will be described in detail.

### First Embodiment

### Configuration of Liquid Ejection Head

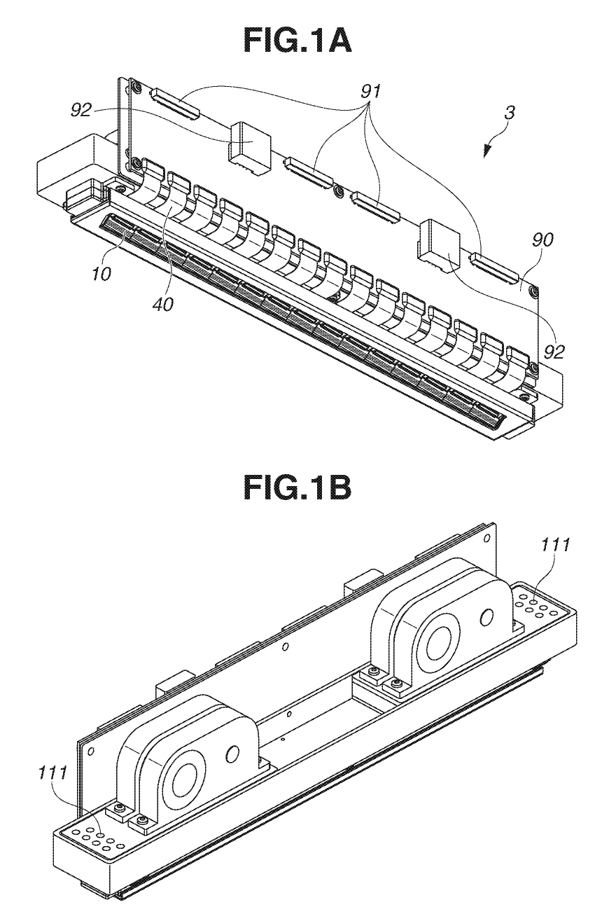

A configuration of a liquid ejection head 3 according to a first embodiment will be described. FIGS. 1A and 1B are perspective views of a liquid ejection head 3 according to the present embodiment. The liquid ejection head 3 is a line-type liquid ejection head in which 15 recording element substrates 10 each capable of ejecting inks of four colors of cyan (C), magenta (M), yellow (Y), and black (K) are arranged on a straight line (arranged in-line). As illustrated in FIG. 1A, the liquid ejection head 3 includes, in addition to the recording element substrates 10, signal input terminals 91 and power supply terminals 92 electrically connected via flexible wiring boards 40 and an electric wiring board 90. The signal input terminals 91 and the power supply terminals 92 are electrically connected to a control unit of a recording device (not illustrated), an ejection driving signal is supplied to the recording element substrates 10 via the signal input terminals 91, and electric power necessary for ejection is supplied to the recording element substrates 10 via the power supply terminals 92.

By consolidating wiring in electric circuitry in the electric wiring board 90, the numbers of signal input terminals 91 and power supply terminals 92 can be reduced compared with the number of recording element substrates 10. This results in a reduced number of electrical connection portions that need to be removed when assembling the liquid ejection head 3 to the recording device or when replacing the liquid ejection head. As illustrated in FIG. 1B, liquid connection portions 111 disposed at both ends of the liquid ejection head 3 are connected to a liquid supply system of the recording device. This allows inks of the four CMYK colors to be supplied from the supply system of the recording device to the liquid ejection head 3, and the ink having passed through the inside of the liquid ejection head 3 to be collected to the supply system of the recording device. In this manner, the ink of each color can circulate via channels of the recording device and the liquid ejection head 3.

### Structure of Recording Element Substrate

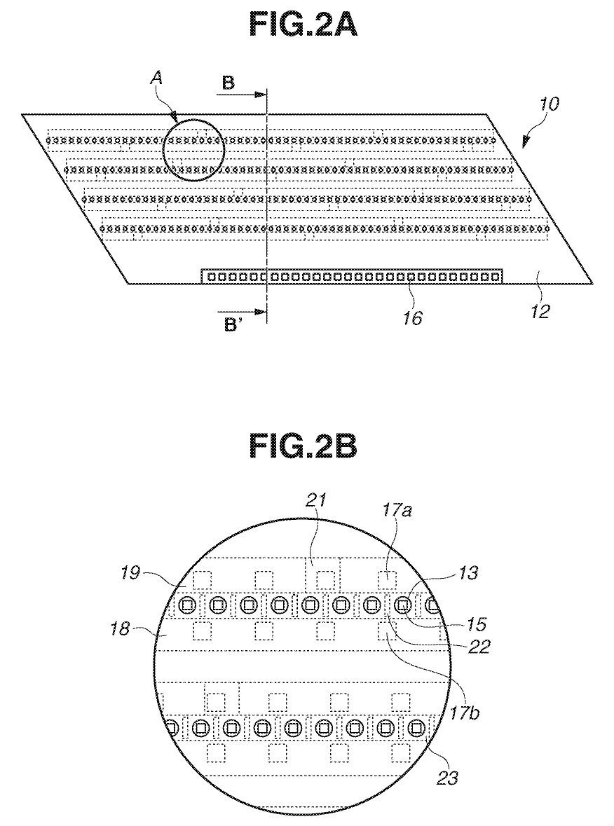

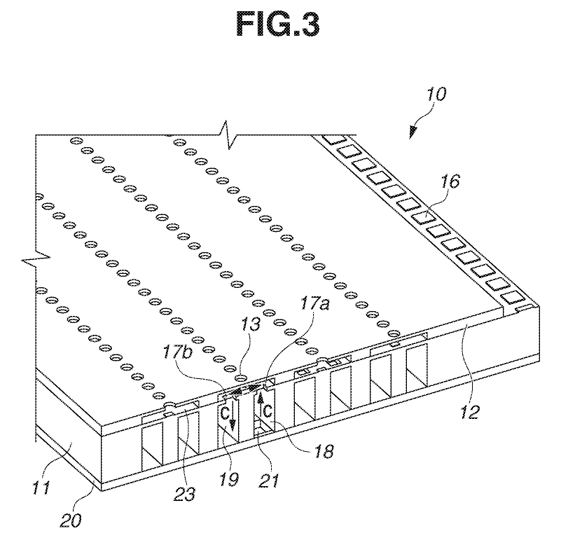

A configuration of a recording element substrate 10 in the present embodiment will be described. FIG. 2A illustrates a plan view of a surface on the side where ejection outlets 13 of the recording element substrate 10 are formed, and FIG. 2B illustrates an enlarged view of the portion indicated by A in FIG. 2A. FIG. 3 is a perspective view illustrating a cross section of the recording element substrate 10 and a cover plate 20 taken along a cross-sectional line B-B' illustrated in FIG. 2A. As illustrated in FIG. 2A, four ejection outlet arrays corresponding to respective ink colors are formed in an ejection outlet forming member 12 of the recording element substrate 10. Hereinafter, a direction in which the ejection outlet arrays in which the plurality of ejection outlets 13 are arranged extends is referred to as an "ejection outlet array direction".

As illustrated in FIG. 2B, heat generating elements 15 from which thermal energy causes ink to bubble are each arranged at a position corresponding to each ejection outlet 13. Pressure chambers 23 each including a heat generating element 15 therein is each defined by a partition wall 22. The heat generating elements 15 are electrically connected to terminals 16 in FIG. 2A via electric wiring (not illustrated) provided on the recording element substrate 10. Each heat generating element 15 generates heat based on a pulse signal input from a control circuit of the recording device via the electric wiring board 90 (FIG. 1) and the corresponding flexible wiring board 40 (FIG. 1) to boil the ink.

The ink is ejected from the ejection outlets 13 by bubbling force generated by this boiling. As illustrated in FIG. 2B, liquid supply channels 18 each extend on one side and liquid collection channels 19 each extend on the other side along the corresponding ejection outlet array. The liquid supply channels 18 and the liquid collection channels 19 are flow channels provided in the recording element substrate 10 and extending in the ejection outlet array direction, and communicate with the corresponding ejection outlets 13 via corresponding supply ports 17a and collection ports 17b, respectively.

As illustrated in FIG. 3, the sheet-like cover plate 20 is laminated on a back surface of the surface on which the ejection outlets 13 are formed of the recording element substrate 10, and the cover plate 20 is provided with a plurality of openings 21 communicating with the liquid supply channels 18 and the liquid collection channels 19 described below.

Next, a flow of ink in the recording element substrate 10 will be described with reference to FIG. 3.

In the recording element substrate 10, a substrate 11 formed of Si and the ejection outlet forming member 12 formed of a photosensitive resin are laminated, and the cover plate 20 is bonded to a back surface of the substrate 11. The heat generating elements 15 are formed on one surface side of the substrate 11, and grooves constituting the liquid supply channels 18 and the liquid collection channels 19 extending along the ejection outlet arrays are formed on the back surface side thereof. A differential pressure is generated between each liquid supply channel 18 and the corresponding liquid collection channel 19 formed with the substrate 11 and the cover plate 20. When recording is performed by ejecting ink from the plurality of ejection outlets 13 of the liquid ejection head 3, this differential pressure in an ejection outlet where the ejection operation is not performed causes ink in the liquid supply channel 18 provided in the substrate 11 to flow as indicated by an arrow C in FIG. 3. That is, the ink flows to the liquid collection channel 19 via the supply port 17a, the liquid supply channel 18, the pressure chamber 23, and the collection port 17b. This ink is finally collected to a supply channel of the recording device.

### Structure of Thermal Action Portion in Recording Element Substrate

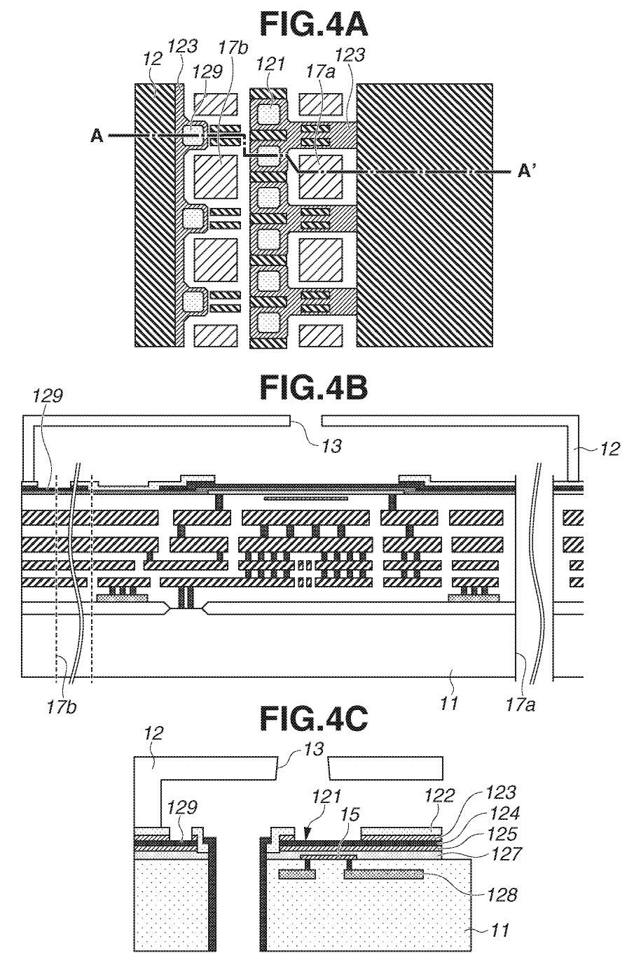

In the following description, a structure of a thermal action portion in a recording element substrate 10 according to the present embodiment will be described with reference to FIGS. 4A to 4C. FIG. 4A is a plan view schematically illustrating an enlarged vicinity of the thermal action portion in the recording element substrate 10. FIG. 4B is a schematic cross-sectional view taken along a long dash-dot line A-A' in FIG. 4A. FIG. 4C is an enlarged schematic cross-sectional view of the vicinity of the thermal action portion in FIG. 4B.

In the liquid ejection head, a plurality of layers is laminated on the substrate 11 formed of silicon to form the recording element substrate. In the present embodiment, a thermal storage layer formed of a thermal oxide film, a SiO film, a SiN film, or the like is arranged on the substrate 11. Further, the heat generating element 15 is arranged on the thermal storage layer, and a wiring layer as wiring formed of a metal material, such as Al, Al-Si, or Al-Cu, is connected to the heat generating element 15 via a heat conducting member. The heat conducting member is typically a plug electrode 128, such as tungsten. As illustrated in FIG. 4C, an insulating protective layer 127 is arranged on the heat generating element 15. The insulating protective layer 127 is provided so as to cover the upper side of the heat generating element 15. The insulating protective layer 127 is formed of a SiO film, a SiN film, or the like.

On the insulating protective layer 127, a protective layer for blocking contact with liquid is disposed. The protective layer, which is composed of a lower protective layer 125, an upper protective layer 124, and an adhesion protective layer 123, protects the surface of the heat generating element 15 from chemical and physical impact resulting from heat generation of the heat generating element 15.

In the present embodiment, the lower protective layer 125 is formed of tantalum (Ta), the upper protective layer 124 is formed of iridium (Ir), and the adhesion protective layer 123 is formed of tantalum (Ta). The protective layers formed of these materials have conductivity. On the adhesion protective layer 123, a protective layer 122 for liquid resistance and for improved adhesion with the ejection outlet forming member 12 is disposed. It is desirable for the protective layer 122 to be formed of a film that is difficult to dissolve in ink, such as SiCN or SiOC. The upper protective layer 124 is formed of a material that contains a metal eluted by an electrochemical reaction and does not form an oxide film preventing heating-induced elution.

When ejection of liquid is performed, an upper portion of the upper protective layer 124 is in contact with the ink, and the upper portion is in a severe environment where the temperature of the liquid instantaneously rises, causing a bubble to occur and collapse, generating cavitation. For this reason, in the present embodiment, the upper protective layer 124 formed of an iridium material having high corrosion resistance and high reliability is adopted. However, platinum (Pt) or the like may be used.

### Countermeasure against Kogation in Recording Element Substrate

In the present embodiment, kogation suppression processing for suppressing kogation depositing on the upper protective layer 124 above the heat generating element 15 is performed during printing. Specifically, a portion, directly above the heat generating element 15, of the upper protective layer 124 is used as one electrode 121 (e.g., a first electrode), a counter electrode 129 (e.g., a second electrode) for the electrode 121 is provided downstream of an ink circulation flow channel, and an electric field via liquid is formed in a liquid chamber. With this configuration, particles charged to negative potential, such as pigment, latex, and wax, in the liquid are repelled from the surface of the upper protective layer 124 above the heat generating element 15. In this manner, the local concentration of particles charged to negative potential, such as pigment, in the vicinity of the surface of the first electrode 121, is reduced, preventing kogation from depositing on the first electrode 121 above the heat generating element 15 during printing. For the kogation prevention, it is considered that a kogation phenomenon occurs in which a coloring material, an additive, and the like included in ink are decomposed at a molecular level by being heated at high temperature, change into sparingly soluble substances, and are physically adsorbed onto the upper protective layer. When the first electrode 121 is heated at high temperature, reducing the local concentration of the coloring material, the additive, and the like causing kogation in the vicinity of the surface of the first electrode 121 above the heat generating element 15 leads to the kogation prevention.

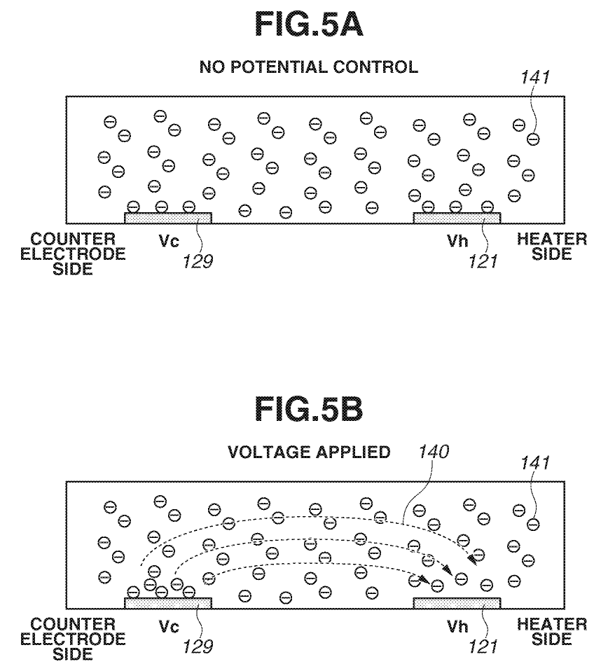

In the following description, a mechanism of electric field control (e.g., also referred to as potential control or potential difference control) used in the present embodiment will be described with reference to FIGS. 5A and 5B. In FIG. 5A, the electrode 121 of the upper protective layer and the counter electrode 129 are arranged in a bubbling chamber, and ink is filled therein. Particles 141, such as pigment, charged to negative potential are contained in liquid, and the particles 141 disperse substantially uniformly in the ink.

FIG. 5B illustrates a state in which a voltage is applied so that the potential of the electrode 121 of the upper protective layer is relatively lower than the potential of the counter electrode 129. For example, the potential difference between the electrode 121 and the counter electrode 129 is about 0.5 to 2.5 V. At this time, an electric field 140 is formed between the first electrode 121 of the upper protective layer and the counter electrode 129 via the liquid. Since the first electrode 121 of the upper protective layer has a negative potential relative to the counter electrode 129, the particles 141 charged to negative potential are repelled from the surface of the first electrode 121 of the upper protective layer, reducing the local concentration of the particles 141 in the vicinity of the surface of the first electrode 121.

From the mechanism as described above, in the present embodiment, as a potential difference ΔV (= Vc - Vh) is larger, where Vc is the potential of the counter electrode and Vh is the potential of the first electrode for the heater (e.g., the heat generating element 15), the particles 141 charged to negative potential, which are a source of kogation, are repelled more, reducing the amount of kogation.

On the other hand, ink may contain metal impurity ions, albeit in trace amounts. When the electrode 121 of the upper protective layer is set to a negative potential as described above, positively charged metal impurity ions may adhere onto the electrode 121, be reduced, and deposit as a metal film.

At this time, kogation adhering to the vicinity of the surface of the first electrode 121 is removed by applying a voltage between the electrode 121 (e.g., the first electrode) and the counter electrode 129 (e.g., the second electrode) for the electrode 121. Conventionally, from an outermost surface layer portion of the upper protective layer 124, a substance is eluted into ink, and the adhering kogation was removed by lift-off. At this time, for example, a voltage of 3 V or higher, at which iridium as the electrode material as the substance is eluted into the ink, is applied between the respective electrodes. It is desirable to apply the voltage while the direction of the voltage applied to the first electrode appears to be reversed. A process of removing kogation accumulated on the heater in this manner is referred to as kogation removal. By this kogation removal, almost no kogation remains on the heater surface layer, which is nearly an initial state. Note that in the following description, a “reversal” of the voltage or “reverse” as the verb refers to a change in the direction of an electric field formed between the first electrode 121 and the counter electrode 129 (second electrode).

### Precipitation of Metal Copper

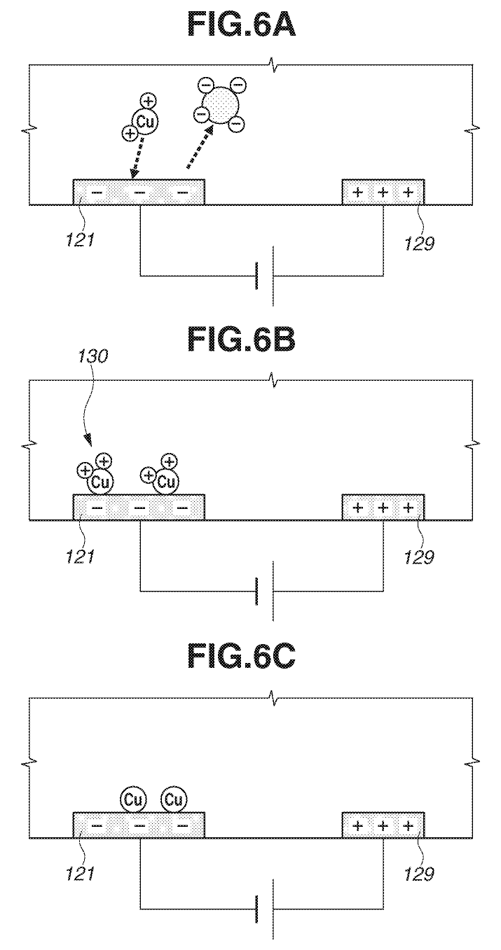

A mechanism by which metal precipitate (metal copper) deposits on the first electrode will be described using FIGS. 6A to 6C. In cyan ink, in addition to negatively charged pigment, wax, and latex, a trace amount of copper ions exists as an impurity originating from a pigment production process. With an increased amount of such a copper ion impurity (> several tens of parts per million (ppm)), copper ions adhere to the surface of the first electrode 121 (FIG. 6B).

Since heat at the time of ink bubbling promotes a reduction reaction of copper ions, the copper ions precipitate and deposit as metal precipitate 130 (e.g., metal copper) (FIG. 6C). At the same time, the heat at the time of ink bubbling also causes organic kogation originating from pigment, wax, and latex to deposit on the surface of the first electrode 121.

Continuous ink ejection in such a state results in unstable ejection due to influence of the metal copper and the organic kogation. Since a voltage is applied to the first electrode 121 so that the first electrode 121 is on the negative potential side, the influence of the metal copper deposit is larger than that of the organic kogation, which may significantly reduce the ejection speed through a cumulative ink ejection of about 1 × 10^8 pulses.

In the kogation removal described above, by applying a voltage (4V) for 50 seconds equal to or higher than the voltage at which Ir (iridium) is eluted from the first electrode 121, the metal copper and the organic kogation can be removed by lift-off.

### Example 1

In the following example, heater ejection durability using cyan pigment ink containing copper phthalocyanine (e.g., containing wax and latex) will be described. Ink was ejected under the following ink and ejection conditions in which metal copper deposits on the first electrode 121.

Ink used: Cyan pigment ink containing copper phthalocyanine Ejection conditions: the temperature of the recording element substrate was controlled at 40° C., and a voltage was applied so that the potential of the electrode 121 was relatively 1.5 V lower than that of the counter electrode 129. In this state, a voltage was applied to the heat generating element 15 while ink was ejected until a cumulative ink ejection of 5 × 10^7 pulses was reached. Metal copper deposited slightly on the first electrode 121, and the ink ejection speed decreased by about 1 m/sec from the initial state.

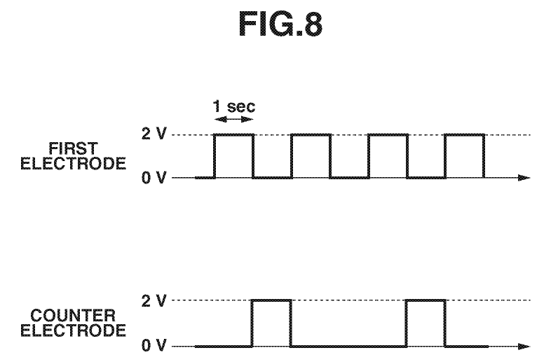

In Example 1, as illustrated in FIG. 8, a voltage of 2 V, which is (i) equal to or lower than a voltage (4 V) at which Ir is eluted (e.g., less than an elution potential) and (ii) equal to or higher than a voltage allowing elution of copper that is precipitated (e.g., equal to or higher than the elution potential), was applied between the first electrode 121 and the counter electrode 129 for 60 seconds while the voltage was reversed. Metal copper has a higher tendency to be ionized than that of Ir, which forms the first electrode 121, and is eluted into the ink at a voltage (≤ 2.5 V) lower than a voltage for Ir.

By this cleaning method, metal copper on the first electrode 121 was removed, and the ejection speed also recovered to a level similar to the initial speed. Furthermore, in the cleaning method of Example 1, since a voltage equal to or lower than a potential at which Ir is eluted is applied, the amount of Ir of the first electrode 121 is not affected even if cleaning is performed. Consequently, the precipitate of metal copper can be removed without eluting Ir from the first electrode 121, allowing repeated cleaning without sacrificing the durability of the liquid ejection head.

### Example 2

In addition to the deposit of metal copper, organic kogation caused by pigment, wax, and latex also deposits on the first electrode 121.

In a case where metal copper precipitates, since ejection speed fluctuation increases through a cumulative ejection of about 1 × 10^8 pulses based on counting the number of ejection times, it may be necessary to perform cleaning frequently by the cleaning method described in Example 1.

On the other hand, organic kogation deposits gradually, so that it is unnecessary to perform kogation removal cleaning as frequently as in the case where metal copper precipitates, and kogation removal cleaning may be performed every 5 × 10^8 pulses. That is, the frequency of performing organic kogation removal is less than the frequency of removing metal precipitate. However, in this case, in order to increase the efficiency of kogation removal, kogation removal may be performed at a high voltage (equal to or higher than the elution potential for the first electrode).

In this manner, by appropriately combining to use both the processes based on whether the kogation is metal precipitate or organic kogation, a highly durable head can be provided which takes countermeasures against metal copper precipitate and organic kogation to allow more stable ink ejection without significantly sacrificing the durability.

### Comparative Example

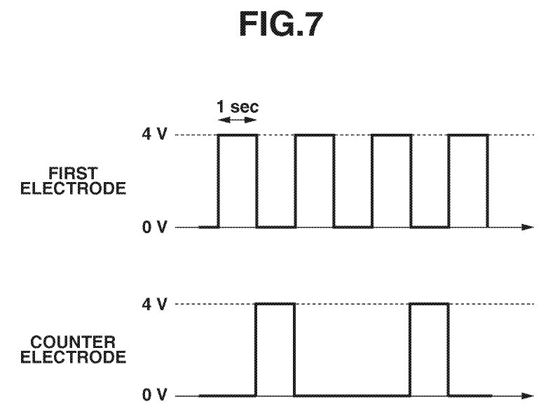

In a comparative example, heater ejection durability using cyan pigment ink containing copper phthalocyanine (e.g., containing wax and latex) will be described. In order to remove metal copper on the first electrode 121 by cleaning, as illustrated in FIG. 7, kogation removal cleaning was performed under a condition that a voltage (4 V) equal to or higher than a voltage at which Ir is eluted is applied between the first electrode 121 and the counter electrode 129 for 60 seconds while the voltage is reversed. The reason for reversing the voltage is that when a positive potential of 4 V is applied to the first electrode 121 without the reversal, negatively charged ink solid content, such as pigment, continues to be attracted. As a result, depending on an ink formulation, the ink solid content may be fixed to the first electrode 121 during a kogation removal cleaning operation, which generates a concern that the cleaning operation becomes ineffective.

By applying a voltage while the voltage is reversed as illustrated in FIG. 7, negatively charged ink solid content, such as pigment, attracted onto the first electrode 121 is separated from the first electrode 121, which allows kogation removal cleaning without fixing pigment.

By this kogation removal cleaning, the metal copper on the first electrode 121 was removed, and the ejection speed also recovered to a level similar to the initial speed. However, the thickness of the first electrode 121, which contains Ir, became thinner by about 2 nm every time kogation removal cleaning was performed. Consequently, the kogation removal cleaning as the conventional technique deteriorates the durability of the head.

### The present disclosure includes the following configurations

### Configuration 1

A cleaning method for a liquid ejection head that includes an ejection outlet configured to eject liquid, a heat generating element configured to heat the liquid to eject the liquid from the ejection outlet, a first electrode disposed on the heat generating element and configured to protect the heat generating element, and a second electrode electrically connected to the first electrode via the liquid, the cleaning method comprising applying a voltage equal to or higher than an elution potential of metal precipitate and lower than an elution potential of a substance from the first electrode between the first electrode and the second electrode to remove the metal precipitate from the first electrode when the liquid is ejected from the ejection outlet.

### Configuration 2

The cleaning method for a liquid ejection head according to Configuration 1, wherein the metal precipitate has a higher tendency to be ionized than a tendency to be ionized of the first electrode.

### Configuration 3

The cleaning method for a liquid ejection head according to Configuration 1 or 2, wherein the first electrode and the second electrode contain iridium.

### Configuration 4

The cleaning method for a liquid ejection head according to any one of Configurations 1 and 2, wherein the first electrode and the second electrode contain platinum.

### Configuration 5

The cleaning method for a liquid ejection head according to Configuration 3, wherein the liquid contains copper ions.

### Configuration 6

The cleaning method for a liquid ejection head according to any one of Configurations 1 to 5, further comprising applying a voltage equal to or higher than the elution potential of the substance from the first electrode between the first electrode and the second electrode.

### Configuration 7

The cleaning method for a liquid ejection head according to Configuration 6, wherein a frequency of applying the voltage equal to or higher than the elution potential of the substance from the first electrode is less than a frequency of applying the voltage lower than the elution potential of the substance from the first electrode.

According to the present disclosure, a cleaning method can be provided which allows removal of metal precipitate on an upper protective layer while suppressing film reduction of the upper protective layer.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037821, filed Mar. 10, 2025, which is hereby incorporated by reference herein in its entirety.

What is claimed is:

1. A cleaning method for a liquid ejection head that includes an ejection outlet configured to eject liquid, a heat generating element configured to heat the liquid to eject the liquid from the ejection outlet, a first electrode disposed on the heat generating element and configured to protect the heat generating element, and a second electrode electrically connected to the first electrode via the liquid, the cleaning method comprising:
applying a voltage equal to or higher than an elution potential of metal precipitate and lower than an elution potential of a substance from the first electrode between the first electrode and the second electrode to remove the metal precipitate from the first electrode when the liquid is ejected from the ejection outlet.

2. The cleaning method for a liquid ejection head according to claim 1, wherein the metal precipitate has a higher tendency to be ionized than a tendency to be ionized of the first electrode.

3. The cleaning method for a liquid ejection head according to claim 1, wherein the first electrode and the second electrode contain iridium.

4. The cleaning method for a liquid ejection head according to claim 1, wherein the first electrode and the second electrode contain platinum.

5. The cleaning method for a liquid ejection head according to claim 3, wherein the liquid contains copper ions.

6. The cleaning method for a liquid ejection head according to claim 1, further comprising applying a voltage equal to or higher than the elution potential of the substance from the first electrode between the first electrode and the second electrode.

7. The cleaning method for a liquid ejection head according to claim 6, wherein a frequency of applying the voltage equal to or higher than the elution potential of the substance from the first electrode is less than a frequency of applying the voltage lower than the elution potential of the substance from the first electrode.
